(19) United States
(12) Patent Application Publication
(10) Pub. No.: US 2017/0200120 A1
(43) Pub. Date: Jul. 13, 2017

(54) SYSTEMS AND METHODS OF ASSISTING IN THE DELIVERY OF PRODUCTS

(71) Applicant: Wal-Mart Stores, Inc., Bentonville, AR (US)

(72) Inventors: Donald R. High, Noel, MO (US); Michael D. Atchley, Springdale, AR (US)

(21) Appl. No.: 15/399,093

(22) Filed: Jan. 5, 2017

Related U.S. Application Data
(60) Provisional application No. 62/275,891, filed on Jan. 7, 2016.

(51) Int. Cl. G06Q 10/08; G06T 11/60

(52) U.S. Cl. CPC G06Q 10/0833; G06T 11/60

(57) ABSTRACT

In some embodiments, apparatuses and methods are provided herein useful in delivering products to customers. In some embodiments, a product delivery assistance system is provided comprising: a wireless transceiver; control circuit; and memory storing computer instructions executed by the control circuit to: obtain placement location information within a delivery vehicle for each of multiple delivery bins defining a placement of the delivery bins within the delivery vehicle; identify a first product order corresponding to a first delivery location; and cause the placement location information of a first delivery bin corresponding to the first product order to be wirelessly communicated to an optical head-mounted display (OHMD) system associated with a delivery worker, and cause the OHMD system to display visual guidance information to guide the delivery worker to the first delivery bin within the delivery vehicle.

### CROSS-REFERENCE TO RELATED APPLICATION

This application claims the benefit of U.S. Provisional Application No. 62/275,891, filed Jan. 7, 2016, which is incorporated herein by reference in its entirety.

### TECHNICAL FIELD

This invention relates generally to fulfilling product orders.

### BACKGROUND

In a modern retail environment, there is a need to improve the customer service and/or convenience for the customer. One aspect of customer service is providing customers with access to products and/or the delivery of products. There are numerous ways to delivery products to customers. Getting the ordered product to the customers, however, can cause undesirable delays, add cost, and reduce revenue.

### BRIEF DESCRIPTION OF THE DRAWINGS

Disclosed herein are embodiments of systems, apparatuses and methods pertaining fulfilling product orders. This description includes drawings, wherein:

FIG. 1 illustrates a simplified block diagram of an exemplary product delivery assistance and/or control system, in accordance with some embodiments.

FIG. 2 illustrates a simplified block diagram of an exemplary Optical Head-Mounted Display (OHMD) system, in accordance with some embodiments.

FIG. 3 illustrates a simplified block diagram of an exemplary delivery management circuit, in accordance with some embodiments.

FIG. 4 illustrates a simplified flow diagram of an exemplary process of providing assistance in product deliveries, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems, apparatuses, processes and methods are provided herein useful to assist in the delivery of products to customers and fulfill product orders. Some embodiments comprise product delivery assistance systems that comprise: a wireless transceiver; control circuit communicatively coupled with the transceiver; and memory communicatively coupled with the control circuit and storing computer instructions that when executed by the control circuit cause the control circuit to obtain placement location information within a delivery vehicle for each of multiple delivery bins that are temporarily placed within the delivery vehicle. The placement location information defines a placement of each of the multiple delivery bins within the delivery vehicle. Each of the delivery bins corresponds to one of multiple different product orders from different customers, and each of the delivery bins temporarily stores at least one product to be delivered to one of the multiple different customers to satisfy the multiple product orders. A first product order can be identified corresponding to a first delivery location. The first product order specifies one or more products ordered by a customer and scheduled to be delivered to the first delivery location. The control circuit can cause the placement location information of one or more delivery bins corresponding to the first product order to be wirelessly communicated to an Optical Head-Mounted Display (OHMD) system associated with a delivery worker, and cause the OHMD system to display visual guidance information and/or audibly reproduce guidance information to guide the delivery worker to the one or more delivery bins within the delivery vehicle corresponding to the first product order and the first delivery location. In some implementations, the control circuit is a control circuit of the OHMD system, while in other implementations, the control circuit is separate from and in communication with the OHMD system. Some embodiments further identify multiple delivery bins within the delivery vehicle and/or accesses placement location information of bins within the delivery vehicle for each of the multiple delivery bins.

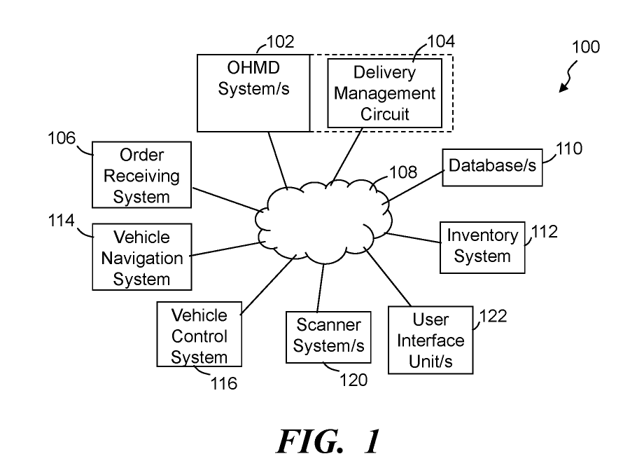

FIG. 1 illustrates a simplified block diagram of an exemplary product delivery assistance and/or control system 100, in accordance with some embodiments. The delivery assistance system includes at least one and typically multiple OHMD systems 102 that are each associated with a different delivery worker, and a delivery management circuit (DMC) 104 that is communicatively coupled with the OHMD systems through one or more wired and/or wireless distributed communication networks 108 (e.g., one or more wired and/or wireless LANs, WANs, Internet, etc.). The OHMD systems and/or delivery management circuit may further communicatively couple with one or more databases 110 and/or other electronic data storage components, which may store product information, customer information, product orders, delivery vehicle mapping information (e.g., 2D and/or 3D mapping of one or more compartments or storage areas where delivery bins are located), delivery bin identifier information, delivery bin content information, delivery bin placement location information, product identifier information, inventory information, retail store information, delivery route information, delivery schedule information, and/or other such information.

The product delivery assistance system 100 typically further includes or is in communication with one or more order receiving systems 106 that receive product orders from customers. In some embodiments, the product delivery assistance system may optionally include and/or communicatively couple with one or more inventory systems 112, one or more vehicle navigation systems 114, a delivery vehicle control circuit or system 116, bin tracking system 118, one or more scanner systems 120, one or more user interface units 122, other relevant systems, or combination of two or more of such systems. Further, in some applications, the delivery management circuit 104 may be part of and/or cooperated into an OHMD system 102.

In some embodiments, the product delivery assistance system 100 is associated with a single retail store into which customers can enter and shop themselves for products that are on display and/or for sale and variously distributed throughout a sales floor within the retail store. In other embodiments, the product delivery assistance system may be distributed over multiple retail stores. Typically, a single customer order is fulfilled through a single retail store. In some situations, however, a single customer order may be fulfilled through more than one retail store (e.g., when a first retail store does not have one or more ordered products). The fulfillment of the orders, in some instances, are fulfilled through one or more retail stores instead of a distribution center, fulfillment warehouse, or the like. The retail store can be substantially any type of shopping facility at a location in which products for display and/or for sale are variously distributed throughout the shopping facility space. The facility may be any size of format facility, and may include products from one or more merchants. For example, a facility may be a single store operated by one merchant or may be a collection of stores covering multiple merchants such as a mall.

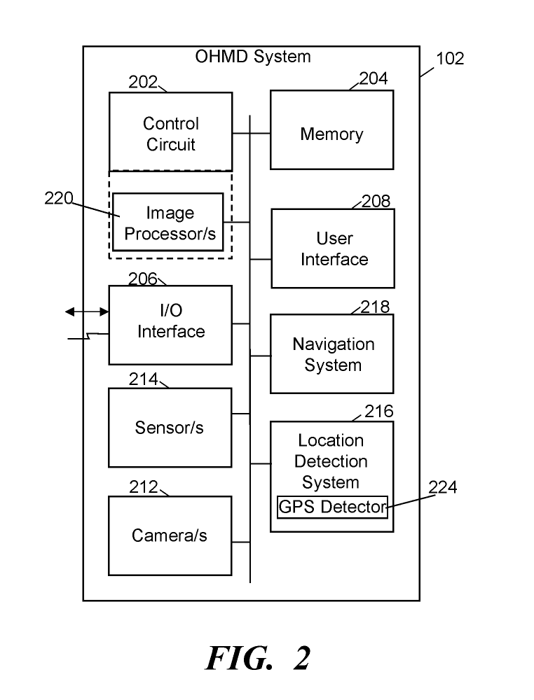

FIG. 2 illustrates a simplified block diagram of an exemplary OHMD system 102, in accordance with some embodiments. The OHMD system includes one or more OHMD control circuits 202, one or more memory 204, one or more input/output (I/O) interfaces and/or devices 206, and one or more user interfaces 208. Some embodiments further include one or more cameras 212, one or more sensors 214, location detection systems 216, one or more navigation systems 218, and/or other such systems and/or circuitry. Additionally, the OHMD system typically includes one or more power supplies (not shown), where one or more of such power supplies may be rechargeable, and/or the OHMD system may at least temporarily receive power from an external source. While FIG. 2 illustrates the various components being coupled together via a bus, it is understood that the various components may actually be coupled to the OHMD control circuit 202 and/or one or more other components directly.

The OHMD control circuit 202 typically comprises one or more processors and/or microprocessors and couples with the memory 204 that stores operational codes or sets of computer instructions that are executed by the OHMD control circuit 202 and/or processor to implement the functionality of the OHMD system 102. For example, in some applications, the OHMD control circuit may include and/or couple with one or more image processors 220 that provide image processing of at least images, which may include video processing, captured by one or more cameras 212 of the OHMD system 102. In some embodiments, the memory 204 may also store some or all of particular data that may be needed to at least provide the worker with the directions in retrieving delivery bins, assistance in locating delivery bins, navigation instructions and/or directions, product information, product identifier information, displaying information, content, distinguishing features and the like, customer information, other such information, or a combination of two or more of such information. The control circuit may further provide sequence of delivery information, unloading order and/or sequence information, delivery vehicle information, compartment information, other such information, or combination of such information.

It is understood that the OHMD control circuit 202 may be implemented as one or more processor devices as are well known in the art. Similarly, the memory 204 may be implemented as one or more memory devices as are well known in the art, such as one or more processor readable and/or computer readable media and can include volatile and/or nonvolatile media, such as RAM, ROM, EEPROM, flash memory and/or other memory technology. Further, the memory 204 is shown as internal to the OHMD system 102; however, the memory 204 can be internal, external and wirelessly accessible, or a combination of internal and external memory.

Generally, the OHMD control circuit 202 and/or electronic components of the OHMD system 102 can comprise fixed-purpose hard-wired platforms or can comprise a partially or wholly programmable platform. These architectural options are well known and understood in the art and require no further description here. The OHMD system and/or OHMD control circuit 202 can be configured (for example, by using corresponding programming as will be well understood by those skilled in the art) to carry out one or more of the steps, actions, and/or functions described herein. In some implementations, the OHMD control circuit 202 and the memory 204 may be integrated together, such as in a microcontroller, application specification integrated circuit, field programmable gate array or other such device, or may be separate devices coupled together.

The I/O interface 206 allows wired and/or wireless communication coupling of the OHMD system 102 to external components, such as the delivery management circuit 104, the order receiving system 106, database 110, inventory system 112, vehicle navigation system 114, vehicle control system 116, bin tracking system 118, scanner system 120, user interface units 122 (e.g., smart phone, tablet, other OHMD system, smart watch systems, and other such consumer electronic user devices), and other such devices or systems. Typically, the I/O interface 206 provides at least wireless communication (e.g., cellular, Wi-Fi, Bluetooth, RF, and/or other such wireless communication), and in some instances may include any known wired and/or wireless interfacing device, circuit and/or connecting device, such as but not limited to one or more transmitter, receiver, transceiver, etc.

The OHMD system further includes one or more user interfaces 208 that can be used for user output and/or input. For example, the user interface 208 may include any known input devices, such one or more buttons, knobs, selectors, switches, keys, touch input surfaces, audio input, and/or displays, audio detector to receive spoken commands, etc. Additionally, the user interface 208 includes one or more display projection systems and corresponding display surfaces (e.g., lens(es) of glasses), lights, visual indicators, etc. to convey information to a worker. Similarly, the user interface 208 in some embodiments may include audio systems that can receive audio commands or requests verbally issued by a worker, and/or output audio content, instructions, alerts and the like.

The OHMD systems 102 typically further include one or more cameras 212 that capture images and/or video that can be evaluated by the OHMD control circuit 202 and/or communicated to the delivery management circuit 104, or other server or service for processing. In operation, the OHMD control circuit 202 can activate one or more of the cameras 212. In some embodiments, one or more pictures and/or video captured by the camera/s 212 of the OHMD system can be evaluated for one or more parameters, rules and/or conditions as described herein.

The location detection system 216 determines and/or obtains location information to determine a current location of and/or track the location and movements of the OHMD system and the worker associated with the OHMD system. In some embodiments, the OHMD control circuit 202 and/or the delivery management circuit 104 can utilize the location information, for example, in identifying a current and/or subsequent delivery location, determine delivery bins to retrieve from the delivery vehicle, provide navigation information, determine information to display and/or audibly reproduce, when to display identifiers and/or highlighting, and the like. Further, the delivery management circuit can utilize the location information communicated from the OHMD system (e.g., determine portions of or all of the delivery bin identifier information, delivery address information, product information, and the like.

Some embodiments may include a navigation system 218 that tracks the OHMD system and a delivery worker's location, and determines relevant navigational commands that should be followed to complete an intended delivery. The navigation commands can be displayed and/or audibly reproduced through the OHMD system providing the worker with guidance. Additionally or alternatively, the OHMD system may be in communication with a separate navigation system external to the OHMD system that provides navigation instructions that are reproduced (visually and/or audibly) by the OHMD system (e.g., a navigation system of the delivery vehicle, a navigation system of the delivery management circuit 104, other such navigation systems or combination of two or more of such navigation systems).

In some instances, the location detection system 216 may include a global positioning detection system or circuit 224 that received global positioning coordinate information, Wi-Fi signal triangulation and/or evaluation system, cellular tower triangulation system, and/or other such location detection system. Further, the location detection system may use information provided by one or more sensors 214 in determining and/or tracking location information. The sensors can include substantially any relevant sensor such as, but not limited to, one or more inertial sensors, accelerometers, gyroscopes, compass, distance measurement systems (e.g., ultrasound, laser, etc.), and/or other such sensor information. The OHMD system 102 may include one or more additional or alternative sensors 214 that provide information that may be used for location detection and navigation, such as but not limited to wireless signal strength sensor, and the like.

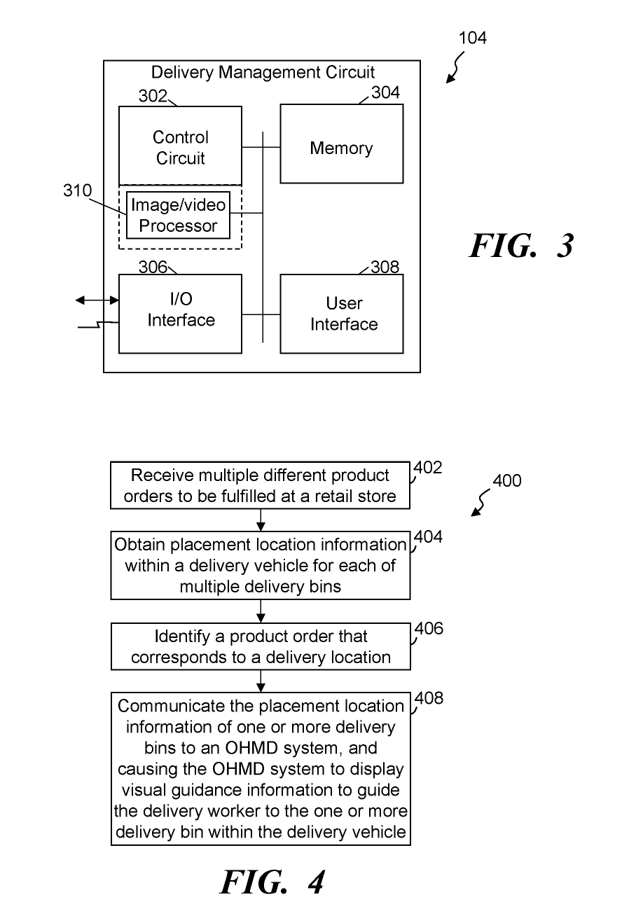

FIG. 3 illustrates a simplified block diagram of an exemplary delivery management circuit 104, in accordance with some embodiments. The delivery management circuit 104 can include one or more delivery management control circuits 302, memory 304, and one or more input/output (I/O) interfaces 306. In some implementations, the delivery management circuit includes one or more user interfaces 308 configured to allow workers to interact with the delivery management circuit to provide relevant information to the delivery management circuit, and/or provide information to the workers. Additionally, in some applications the delivery management circuit includes and/or couples with one or more image and/or video processors 310 that provide image processing of at least images, which may include video processing, captured by one or more cameras 212 of the OHMD systems 102. While FIG. 3 illustrates the various components being coupled together via a bus, it is understood that the various components may actually be coupled to the control circuit 302 and/or one or more other components directly.

In some embodiments, the control circuit 302 comprises one or more processors and/or microprocessors. The control circuit couples with and/or includes the memory 304. Generally, the memory 304 stores the operational code or one or more sets of computer instructions that are executed by the control circuit 302 and/or processor to implement the functionality of the delivery management circuit. In some implementations, the memory may further stores some or all of particular data that may be needed to at least provide the worker with the directions in retrieving delivery bins, assistance in locating delivery bins, navigation instructions and/or directions, product information, product identifier information, displaying information, content, distinguishing features and the like, customer information, other such information, or a combination of two or more of such information. Such data may be pre-stored in the memory or be received.

It is understood that the control circuit may be implemented as one or more processor devices as are well known in the art. Further, the control circuit may utilize remote processors dispersed over a distributed communication network (e.g., LAN, WAN, Internet, etc.). Similarly, the memory 304 may be implemented as one or more memory devices as are well known in the art, such as one or more processor readable and/or computer readable media and can include volatile and/or nonvolatile media, such as RAM, ROM, EEPROM, flash memory and/or other memory technology. Further, the memory 304 is shown as internal to the delivery management circuit; however, the memory 304 can be internal, external or a combination of internal and external memory. Similarly, the memory may be dispersed over a distributed communication network.

In some instances, the control circuit 302 and the memory 304 may be integrated together, such as in a microcontroller, application specification integrated circuit, field programmable gate array or other such device, or may be separate devices coupled together. In some applications, the control circuit 302 comprises a fixed-purpose hard-wired platform or can comprise a partially or wholly programmable platform. These architectural options are well known and understood in the art and require no further description here. The control circuit can be configured (for example, by using corresponding programming as will be well understood by those skilled in the art) to carry out one or more of the steps, actions, and/or functions described herein.

The one or more I/O interfaces 306 allow wired and/or wireless communication coupling of the delivery management circuit 104 to external components such as, but not limited to, one or more OHMD systems 102, the order receiving system 106, the databases 110, the inventory system 112, the vehicle navigation system 114, the vehicle control system 116, one or more scanner systems 120, one or more user interface units 122, and other such components. Accordingly, the I/O interface 306 may include any known wired and/or wireless interfacing device, circuit and/or connecting device, such as but not limited to transceivers, receivers, transmitters, and the like. For example, in some implementations, the I/O interface 306 provides wireless communication in accordance with one or more wireless protocols (e.g., cellular, Wi-Fi, Bluetooth, radio frequency (RF), other such wireless communication, or combinations of such communications).

In some embodiments the delivery management circuit may include and/or couple with one or more user interfaces 308. The user interface can include substantially any known input device, such one or more buttons, knobs, selectors, switches, keys, touch input surfaces, scanners, displays, etc. Additionally, the user interface may include one or more output display devices, such as lights, visual indicators, display screens, etc. to convey information to a user, such as product priority, threshold information, inventory information, product information, product identifiers, notifications, errors, conditions and/or other such information.

The delivery assistance system 100, in part, utilizes the OHMD systems 102 to help delivery workers in delivering products to customers. Some embodiments obtain placement location information within a delivery vehicle for each of multiple delivery bins that have been previously placed into the delivery vehicle. As introduced above, workers collect and consolidate product for multiple orders. The consolidated one or more products for each product order are place into one or more delivery bins, and loaded into the delivery vehicle according to a loading sequence and/or order of loading corresponding to each delivery vehicle. In some implementations, the loading order is defined in reverse order relative to the sequence of delivery of the multiple product orders being delivered by a delivery vehicle. For example, in some instances, the loading order is such that one or more delivery bins associated with a product order scheduled to be delivered last are to be loaded into the delivery vehicle first, and one or more delivery bins associated with a product order scheduled to be delivered first are to be loaded into the delivery vehicle last to the determined delivery. As such, the one or more delivery bins associated with a first scheduled delivery are outer most and readily accessible by the delivery worker. The collection and/or picking of products at the retail store in accordance with some embodiments is described in U.S. Provisional Application No. 62/275,871, for Donald R. High et al., entitled SYSTEMS AND METHODS OF FULFILLING PRODUCT ORDERS, and U.S. patent application Ser. No. 15/398,103, filed Jan. 4, 2017, and entitled SYSTEMS AND METHODS OF FULFILLING PRODUCT ORDERS, which are incorporated herein by reference in their entirety. Further, the consolidation and loading of products and delivery bins according to product orders into one or more delivery vehicles is described in accordance with some embodiments in U.S. Provisional Application No. 62/275,886, for Donald R. High et al., entitled SYSTEMS AND METHODS OF CONSOLIDATING PRODUCT ORDERS, which is incorporated herein by reference in its entirety.

The placement location information at least in part defines a placement of the delivery bins within the delivery vehicle, and each of the delivery bins corresponds to one of multiple different product orders from different customers that are scheduled to be delivered by the delivery vehicle. Each delivery bin stores at least one product to be delivered to one of the multiple different customers to satisfy the multiple product orders. The placement information can provide information to the delivery worker to help the worker identify the one or more delivery bins intended for a particular delivery location. In some implementations, the placement information can include coordinate information corresponding to one or more locations within the delivery vehicle, placement locations in a designated rack (e.g., number of bin locations along a rack, between two coordinates of a designated rack, etc.), a compartment of the delivery vehicle in which a delivery bin is located, when the delivery vehicle includes multiple compartments, a rack number when multiple racks are included (e.g., a rack number within a designated compartment), other such relevant placement location information that can be used by the delivery worker to locate a delivery bin within the delivery vehicle, or a combination of two or more of such information. For example, a delivery vehicle may include five different compartments, with five different racks in one or more of the compartments, with space in each rack for ten different delivery bins, and the placement location information for a first delivery bin may specify a compartment identifier (e.g., compartment 1), a rack within that compartment (e.g., rack 3), and a bin space along the specified rack (e.g., space 1, which may be closest to the door of the compartment in some implementations). Further, the order of loading the delivery bins can further aid the delivery worker because, in some implementations, the one or more bins for a particular delivery location should be an outer most bin space on a particular rack.

For each product order, the product order being delivered is identified. The product order corresponds to a corresponding delivery location. The identification of the product order may be in response to tracking the location of the delivery vehicle, in response to identifying that a subsequently scheduled delivery was completed, in response to a worker requesting the product order information and/or the delivery location, other such factors, or combination of two or more of such factors. Typically, this information is compiled in response to one or more workers loading the delivery vehicle, which may include confirming an accurate placement consistent with the delivery schedule and/or loading order.

The placement location information of the one or more delivery bins corresponding to the product order is wirelessly communicated to the OHMD system 102 associated with a delivery worker. The communication of the placement location information can occur prior to the OHMD system leaving the retail store, based on a determined current location of the delivery vehicle, in response to identifying that one of a scheduled product delivery was completed, in response to a worker requesting the placement location information and/or a delivery address, other such factors, or combination of two or more of such factors.

The OHMD system can then be caused to display visual guidance information and/or reproduce audio guidance information to guide the delivery worker to one or more delivery bins within the delivery vehicle and corresponding to a product order to be delivered. In some implementations, the OHMD system in displaying the visual guidance information merely displays the placement location information. For example, the OHMD system may display a listing of the delivery bins corresponding to a particular order and corresponding placement location information. Some embodiments may additionally or alternatively display and/or audibly provide further information, such as coordinate information, more details about the placement location information, display the placement location information and corresponding delivery bin identifier information sequentially for a delivery location, and/or other such additional information.

Further, some embodiments may provide additional assistance and/or guidance information to the delivery worker in identifying one or more compartments of a delivery vehicle and/or delivery bins to be retrieved for a delivery location. This can include distinguish one or more compartments and/or delivery bins from other compartments and/or other delivery bins. This distinguishing can be through displaying a highlighting and/or a displayed different color overlay in the field of view of the delivery worker where the delivery bin is located. In some applications, the OHMD systems capture images and/or video. The images and/or video can be processed by the OHMD system and/or forwarded to the delivery management circuit (and/or a separate image processing and/or video processing system). One or more delivery bins can be identified and their locations within the field of view of the worker can be determined. With this information, the OHMD system and/or the delivery management system can cause one or more distinctions to be displayed (e.g., change of coloring, a circle displayed around a delivery bin of interest, or the like) in the field of view of the worker that distinguishes one or more delivery bins or compartments from which the worker is to retrieve a deliver bin. Similar audio information can be played back to further aid the worker in identifying a delivery bin. For example, the control circuit in causing the OHMD system to display visual guidance information further can cause the OHMD system to display a highlighting that visually distinguishes one or more delivery bins of the multiple delivery bins within the delivery vehicle that correspond to a particular product order. Again, some embodiments further identify a compartment or compartments of the delivery vehicle where delivery bins of a product order are located. The control circuit can cause the OHMD system to visually distinguish and/or identify each compartment of the multiple different compartments of the delivery vehicle in which at least one of the delivery bins corresponding to a particular product order is located. The visual distinction can include, but is not limited to, displaying a highlighting, displaying a changed color, overlaying a circle or other such indicator, other such distinctions or combination of two or more of such distinctions.

Some embodiments confirm that correct delivery bins are pulled from the delivery vehicle corresponding to delivery locations and product orders. The control circuit may receive delivery bin identifier information corresponding to a delivery bin of the multiple delivery bins in response to the delivery bin being removed from the delivery vehicle. In some instances, for example, the OHMD system may capture one or more image and/or video of the delivery bin that can be used to detect and/or recognize identifier information (e.g., bar code, identifier number, etc.), the OHMD system or other scanner system 120 can detect identifier information (e.g., bar code information, RFID information, etc.), or other such identifying information. Other identifier information can include, but is not limited to, a shape of the delivery bin and/or product, identifier information of one or more products within the delivery bin, placement in the delivery vehicle of the delivery bin, etc., other such information, or combination of two or more of such information. Using the information, the delivery bin and/or product removed (or being removed) from the delivery vehicle can be confirmed as the correct delivery bin and/or one or more products consistent with the product order and delivery location.

Further, some embodiments cause a notification to be generated by the OHMD system 102 notifying the delivery worker that the delivery bin removed from the delivery vehicle does not correspond with the product order. The notification can be a visual notification that is displayed through the OHMD system, an audible notification generated through the OHMD system, one or more lights or other indicators may be activated on the delivery bin or on the delivery vehicle, activating a user interface unit 122 associated with the delivery worker, other such notification, or combination of two or more of such notifications.

The delivery routes may be optimized based on intended delivery locations of the multiple orders, and some applications provide navigation through the OHMD system to help guide the delivery worker to the correct delivery locations in accordance with the optimized delivery route. The optimization may attempt to optimize time to achieve the deliveries, optimize fuel efficiency, optimize distance traveled, other such optimization, or optimization based on some combination of two or more of such aspects that can affect the delivery routing. Further, some embodiments may take into consideration delivery priorities of one or more product orders (e.g., based on temperate critical products, customer paying for higher priority, customer only available to receive the delivery during a limited window of time, or other such aspects). Each of the multiple different product orders scheduled to be delivered by the delivery vehicle and corresponding delivery locations can be identified. Predetermined delivery routes can be determined for each of one or more delivery vehicles. The delivery routes are defined over multiple different roads and along which the delivery vehicles are to travel to each of the multiple different delivery locations. Again, the optimization can be based on reducing or minimizing a duration of time to perform deliveries of the multiple different product orders, reducing or minimizing distance traveled, reducing or minimizing fuel consumption, accommodating priority deliveries, limiting exposure to adverse traffic conditions, taking into consideration traffic congestion, taking into consideration one or more delivery workers' experience, taking into consideration one or more delivery workers' knowledge and/or previous exposure to delivery locations and/or areas in which delivery locations are located, other such factors, or combination of two or more of such factors. The predetermined delivery routes are determined taking into consideration the multiple different delivery location stops that the delivery vehicle has to make, and typically is defined prior to delivery bins and/or products being loaded into the delivery vehicle.

The determined route information corresponding to the predetermined delivery route is communicated to the OHMD system and/or the vehicle navigation system 114, which may communicate some or all of the information to the OHMD system. The OHMD system is caused to generate navigation commands and/or notifications (referred to herein generally as commands) based on the route information corresponding to a current location of the OHMD system. The navigation commands are intended to be followed by the delivery worker as the delivery vehicle travels along the predefined delivery route. The navigation commands can be presented through display and/or audio.

In some embodiments, the navigation commands include displayed commands that appear to the delivery worker as overlays on the road along which the delivery vehicle is traveling. The control circuit causes the OHMD system to display visual overlays that when viewed by the delivery worker appear as overlays on a road being traveled and correspond to the navigation commands based on a current geographic global position of the OHMD system. The position information may be provided by the location detection system 216 of the OHMD system, from the vehicle navigation system, or other source. The navigation commands can be substantially any relevant navigation commands and can be determined to implement the delivery route and/or modify the route based on current conditions (e.g., notification of congestion, change corresponding to a particular product order, etc.). For example, the commands can include notifying of upcoming turns, notifying when to make turns, notifying what direction to turn, notifying when to change lanes in anticipation of turns, notification of speed limits and/or whether the delivery vehicle is within the speed limit, distances to turns, distances to delivery locations, other such commands, or a combination of two or more of such commands. Again, the commands may be visual and/or audible. For example, an audible navigation command will alert the driver a quarter mile before each turn the driver is to make. In some instances, once a driver makes a turn the driver may be informed immediately of a subsequent turn, stop, lane change, or other subsequent action. This cycle can be repeated until a delivery location reached, with the cycle repeating for a subsequent delivery location and/or returning to the shopping facility or other vehicle storage location. In some applications, the visual navigation may be capable of providing visual 4D (three dimensions and time) overlays that appear to the driver over the roads. As the driver drivers down the road the visual navigation can, for example, distinguish lanes, signs, streets, buildings, and the like (e.g., displaying lights consistent with a lane, highlighting a sign, etc.). Typically, when it is time for a turn the OHMD system notifies and/or displays turns before they arise. The system may further detect discrepancy when they occur (e.g., missed turn, unable to make a turn, one-way street, etc.), and can determine a best detour available and recalibrate the delivery route and provide relevant navigation commands.

The delivery assistance system 100 can, in some applications, further assist the worker allowing contact with a customer (e.g., calling a customer, text message, email, etc., which may depend on customer preference) to confirm the delivery, delivery location, delivery time, provide a notification of a delay, provide an updated estimated time of delivery, and/or other such aspects of the delivery. In some embodiments, the OHMD system and/or delivery management circuit identifies, based on location information corresponding to changing locations of the delivery vehicle as the delivery vehicle travels toward a delivery location, when an anticipated delivery time of a product order is within a delivery threshold period of time. The estimated time can be based on historic information, current traffic conditions, and the like. Some embodiments cause the OHMD system to initiate contact with a customer receiving the product order to notify the customer regarding the anticipated delivery time. For example, when the delivery vehicle is within an estimated 15 minutes of arrival to the delivery location, a courtesy call, email, text, and/or other such method is automatically triggered and implemented by the OHMD system to alert the customer. Upon reaching the delivery location the OHMD system further be triggered to notify the customer and/or provide guidance and/or navigation to the delivery worker to accurately identify the correct one or more delivery bins and/or products (e.g., providing visual and/or audio guidance, such as placement location information, bin number, etc.) and/or navigation to the intended address.

As introduced above, in some instances the delivery bins are organized first-in-last-out, and highlighting can be displayed to help in locating the correct bins and/or products. In some embodiments, the control circuit identifies one or more delivery bins of the multiple delivery bins corresponding to a product order and their placement location within the delivery vehicle placed in reverse delivery order in accordance with the predetermined delivery route. The OHMD system can be caused to display highlighting to visually distinguish each of the one or more delivery bins within the delivery vehicle that correspond to a delivery location.

FIG. 4 illustrates a simplified flow diagram of an exemplary process 400 of providing assistance in product deliveries, in accordance with some embodiments. In step 402, multiple different product orders for one or more requested products to be fulfilled at a retail store are received through a consolidation management circuit of a customer order fulfillment system associated with a retail store. In step 404, placement location information is obtained within a delivery vehicle for each of multiple delivery bins defining a placement of the delivery bins and/or products within the delivery vehicle. Each of the delivery bins corresponds to one of multiple different product orders from different customers, and each of the delivery bins stores at least one product to be delivered to one of the multiple different customers to satisfy the multiple product orders. In step 406, a product order is identified that corresponds to a delivery location.

In step 408, the placement location information of one or more delivery bins corresponding to the product order is wirelessly communicated to an OHMD system associated with a delivery worker, and causing the OHMD system to display visual guidance information to guide the delivery worker to the one or more delivery bin within the delivery vehicle corresponding to the product order. Some embodiments in causing the OHMD system to display visual guidance information further causes the OHMD system to display a highlighting that visually distinguishes the one or more delivery bins of the multiple delivery bins (and/or one or more products) within the delivery vehicle that correspond to the product order.

Some embodiments further identify one or more compartments of the delivery vehicle where the delivery bins and/or products of an order are located. In causing the OHMD system to display the visual guidance information some embodiments cause the OHMD system to identify and/or visually distinguish each compartment of multiple different compartments of the delivery vehicle in which at least one of a plurality of the delivery bins and/or products, corresponding to the product order being delivered, is located. Using the OHMD system, some embodiments further confirm that the delivery bins and/or products being pulled from the delivery vehicle are correct for the product order being delivered at the current delivery location. For example, one or more delivery bin identifiers (and/or product identifiers) can be received through and/or from the OHMD system corresponding to the delivery bin of the multiple delivery bins in response to the delivery bin being removed from the delivery vehicle. The OHMD system can cause a notification to be generated notifying the delivery worker that the delivery bin removed from the delivery vehicle does not correspond with the product order currently being delivered. In some implementations, the system further directs the loading of the delivery bins and/or products in accordance with a first-in-last-out organization. The OHMD system identifies one or more, and in some instances a plurality, of delivery bins of the multiple delivery bins corresponding to a first product order and their placement location within the delivery vehicle placed in reverse delivery order in accordance with the predetermined delivery route. The OHMD system can further display highlighting and/or other such visual graphics to visually distinguish each of the one or more delivery bins within the delivery vehicle corresponding to the product order associated with a current delivery location at which the OHMD system is currently located.

In some embodiments, the delivery management circuit further optimizes delivery routes of the multiple orders and provides navigation consistent with the determine delivery routes to the OHMD systems to provide guidance to delivery workers wearing the OHMD systems. Some embodiments identify each of the multiple different product orders schedule to be delivered by the delivery vehicle and corresponding delivery locations. One or more predetermined delivery routes are determined over multiple different roads and along which the one or more delivery vehicles are to travel to each of the multiple different delivery locations. In some embodiments, the delivery routes are defined to minimize a duration of time to perform deliveries of the multiple different product orders. Route information corresponding to a different one of the predetermined delivery routes is communicated to each of the OHMD systems associated with a delivery worker and/or driver. The OHMD system generates navigation commands based on the route information corresponding to a current location of the OHMD system and that are to be followed by the delivery worker as the delivery vehicle travels along the predefined delivery route. The navigation commands can include displayed commands that appear as overlays on the road. In some instances, the OHMD system can display visual overlays that when viewed by the delivery worker appear as overlays on a road being traveled and correspond to the navigation commands based on a current geographic global position of the OHMD system.

In attempt to improve customer relations and/or to further help the delivery worker, the OHMD system can be configured to call a customer when it is estimated that the delivery time is within a threshold time of delivery. Based on location information corresponding to changing locations of the delivery vehicle as the delivery vehicle travels toward the first delivery location, the OHMD system and/or the delivery management circuit can identify when an anticipated delivery time of a product order is within a delivery threshold period of time. The control circuit can cause the OHMD system to initiate contact with a customer receiving the product order to notify the customer regarding the anticipated delivery time.

In some embodiments, the delivery worker and/or driver uses the OHMD system or a separate scanner system 120 to obtain identifier information of a delivery vehicle. The OHMD system can communicate with the delivery management system and confirm the delivery worker is scheduled to drive the identified delivery vehicle. The vehicle identifier information can include, but is not limited to, bar code data, RFID information, one or more images that can be processed to determine an identification of the delivery vehicle (e.g., based on a vehicle number, or other such markings), other such information, or combination of such information. Once identified, a delivery information can be retrieved. The delivery information can include product orders to be delivered by the delivery vehicle, navigation information, delivery route information, product information, customer information and/or other such information. In some instances, some or all of the delivery information may be communicated to the OHMD system. Again, the OHMD system can use the delivery information to determine a delivery route. This route information may be updated and/or modified by the delivery management circuit and/or the OHMD system based on real time GPS information, GEO location technology information, and/or other relevant location information. Some or all of the predetermined delivery route information can be communicated to the OHMD system and/or navigation commands can be communicated to the OHMD system to be provided to the delivery worker to route the driver to correct delivery location. The navigation commands can be provided visually or audibly. The delivery management circuit and/or OHMD system can use real time GPS and other information (e.g., news, road work reports, accident reports, etc.) to ensure driver is on a desired route (e.g., the fastest path, most economical path, etc.), and/or to update a delivery route.

Using the delivery bin placement location information, the OHMD system can display visual and audio guidance the worker to locate the relevant one or more delivery bins and/or products intended for a current delivery location. For example, the OHMD system can display and/or audibly provide a delivery bin numbers, a rack number, a bin space, a compartment identifier, or other such information or combination of such information in guiding the worker to retrieve the correct one or more delivery bins and/or products for a current delivery location. The OHMD system can further be utilized to confirm the accuracy of a delivery bin and/or product pulled from the delivery vehicle for a current delivery location.

In some embodiments, one or more cameras 212 of the OHMD system can be activated while a delivery is in progress to confirm customer receives the ordered products and/or for quality customer care assurance. In some implementations, when a consumer receives the one or more ordered products, the customer can be requested to confirm the delivery (e.g., audibly confirm their order). The OHMD system can capture the audio and/or video of the delivery and can communicate that information to the delivery management system or other remote system.

In some embodiments, systems, apparatuses and methods are provided to fulfill product orders. Some embodiments comprise product delivery assistance system, comprising: a wireless transceiver; control circuit coupled with the transceiver; and memory storing computer instructions that when executed by the control circuit cause the control circuit to: obtain placement location information within a delivery vehicle for each of multiple delivery bins defining a placement of the delivery bins within the delivery vehicle, wherein each of the delivery bins corresponds to one of multiple different product orders from different customers, and each of the delivery bins stores at least one product to be delivered to one of the multiple different customers to satisfy the multiple product orders; identify a first product order corresponding to a first delivery location; and cause the placement location information of a first delivery bin corresponding to the first product order to be wirelessly communicated to an optical head-mounted display (OHMD) system associated with a delivery worker, and cause the OHMD system to display visual guidance information to guide the delivery worker to the first delivery bin within the delivery vehicle.

Some embodiments include methods of providing assistance in product deliveries, comprising: by a control circuit: obtaining placement location information within a delivery vehicle for each of multiple delivery bins defining a placement of the delivery bins within the delivery vehicle, wherein each of the delivery bins corresponds to one of multiple different product orders from different customers, and each of the delivery bins stores at least one product to be delivered to one of the multiple different customers to satisfy the multiple product orders; identifying a first product order corresponding to a first delivery location; and causing the placement location information of a first delivery bin corresponding to the first product order to be wirelessly communicated to an optical head-mounted display (OHMD) system associated with a delivery worker, and causing the OHMD system to display visual guidance information to guide the delivery worker to the first delivery bin within the delivery vehicle.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A product delivery assistance system, comprising:
a wireless transceiver;
control circuit coupled with the transceiver; and
memory storing computer instructions that when executed by the control circuit cause the control circuit to:
obtain placement location information within a delivery vehicle for each of multiple delivery bins defining a placement of the delivery bins within the delivery vehicle, wherein each of the delivery bins corresponds to one of multiple different product orders from different customers, and each of the delivery bins stores at least one product to be delivered to one of the multiple different customers to satisfy the multiple product orders;
identify a first product order corresponding to a first delivery location; and
cause the placement location information of a first delivery bin corresponding to the first product order to be wirelessly communicated to an optical head-mounted display (OHMD) system associated with a delivery worker, and cause the OHMD system to display visual guidance information to guide the delivery worker to the first delivery bin within the delivery vehicle.

2. The system of claim 1, wherein the control circuit in causing the OHMD system to display visual guidance information is further configured to cause the OHMD system to display a highlighting that visually distinguishes the first delivery bin of the multiple delivery bins within the delivery vehicle that corresponds to the first product order.

3. The system of claim 2, wherein the control circuit in causing the OHMD system to display the visual guidance information is further configured to cause the OHMD system to visually distinguish each compartment of multiple different compartments of the delivery vehicle in which at least one of a plurality of the delivery bins, corresponding to the first product order, is located.

4. The system of claim 1, wherein the control circuit is further configured to:
receive, from the OHMD system, delivery bin identifier information corresponding to the first delivery bin of the multiple delivery bins in response to the first delivery bin being removed from the delivery vehicle; and
cause a notification to be generated by the OHMD system notifying the delivery worker that the first delivery bin removed from the delivery vehicle does not correspond with the first product order.

5. The system of claim 1, wherein the control circuit is further configured to:
identify each of the multiple different product orders scheduled to be delivered by the delivery vehicle and corresponding delivery locations;
determine a predetermined delivery route over multiple different roads and along which the delivery vehicle is to travel to each of the multiple different delivery locations to minimize a duration of time to perform deliveries of the multiple different product orders; and
communicate route information corresponding to the predetermined delivery route and cause the OHMD system to generate navigation commands based on the route information corresponding to a current location of the OHMD system and that are to be followed by the delivery worker as the delivery vehicle travels along the predefined delivery route.

6. The system of claim 5, wherein the control circuit in causing the OHMD system to generate navigation commands is further configured to cause the OHMD system to display visual overlays that when viewed by the delivery worker appear as overlays on a road being traveled and correspond to the navigation commands based on a current geographic global position of the OHMD system.

7. The system of claim 5, wherein the control circuit is further configured to:
identify, based on location information corresponding to changing locations of the delivery vehicle as the delivery vehicle travels toward the first delivery location, when an anticipated delivery time of the first product order is within a delivery threshold period of time; and
cause the OHMD system to initiate contact with a first customer receiving the first product order to notify the first customer regarding the anticipated delivery time.

8. The system of claim 5, wherein the control circuit in causing the OHMD system to display visual guidance information is further configured to identify a plurality of delivery bins of the multiple delivery bins corresponding to the first product order and their placement location within the delivery vehicle placed in reverse delivery order in accordance with the predetermined delivery route and cause the OHMD system to display highlighting to visually distinguishes each of the plurality of delivery bins within the delivery vehicle.

9. A method of providing assistance in product deliveries, comprising:
by a control circuit:
obtaining placement location information within a delivery vehicle for each of multiple delivery bins defining a placement of the delivery bins within the delivery vehicle, wherein each of the delivery bins corresponds to one of multiple different product orders from different customers, and each of the delivery bins stores at least one product to be delivered to one of the multiple different customers to satisfy the multiple product orders;
identifying a first product order corresponding to a first delivery location; and
causing the placement location information of a first delivery bin corresponding to the first product order to be wirelessly communicated to an optical head-mounted display (OHMD) system associated with a delivery worker, and causing the OHMD system to display visual guidance information to guide the delivery worker to the first delivery bin within the delivery vehicle.

10. The method of claim 9, wherein the causing the OHMD system to display visual guidance information further comprises causing the OHMD system to display a highlighting that visually distinguishes the first delivery bin of the multiple delivery bins within the delivery vehicle that corresponds to the first product order.

11. The method of claim 10, wherein the causing the OHMD system to display the visual guidance information further comprises causing the OHMD system to visually distinguish each compartment of multiple different compartments of the delivery vehicle in which at least one of a plurality of the delivery bins, corresponding to the first product order, is located.

12. The method of claim 9, further comprising:
receiving, from the OHMD system, a delivery bin identifier information corresponding to the first delivery bin of the multiple delivery bins in response to the first delivery bin being removed from the delivery vehicle; and
causing a notification to be generated by the OHMD system notifying the delivery worker that the first delivery bin removed from the delivery vehicle does not correspond with the first product order.

13. The method of claim 9, further comprising:
identifying each of the multiple different product orders schedule to be delivered by the delivery vehicle and corresponding delivery locations;
determining a predetermined delivery route over multiple different roads and along which the delivery vehicle is to travel to each of the multiple different delivery locations to minimize a duration of time to perform deliveries of the multiple different product orders; and
communicating route information corresponding to the predetermined delivery route and cause the OHMD system to generate navigation commands based on the route information corresponding to a current location of the OHMD system and that are to be followed by the delivery worker as the delivery vehicle travels along the predefined delivery route.

14. The method of claim 13, wherein the causing the OHMD system to generate navigation commands further comprises causing the OHMD system to display visual overlays that when viewed by the delivery worker appear as overlays on a road being traveled and correspond to the navigation commands based on a current geographic global position of the OHMD system.

15. The method of claim 13, further comprising:
identifying, based on location information corresponding to changing locations of the delivery vehicle as the delivery vehicle travels toward the first delivery location, when an anticipated delivery time of the first product order is within a delivery threshold period of time; and
causing the OHMD system to initiate contact with a first customer receiving the first product order to notify the first customer regarding the anticipated delivery time.

16. The method of claim 13, wherein the causing the OHMD system to display visual guidance information further comprises identifying a plurality of delivery bins of the multiple delivery bins corresponding to the first product order and their placement location within the delivery vehicle placed in reverse delivery order in accordance with the predetermined delivery route and causing the OHMD system to display highlighting to visually distinguishes each of the plurality of delivery bins within the delivery vehicle.
